(19) United States
(12) Patent Application Publication
(10) Pub. No.: US 2010/0078901 A1
(43) Pub. Date: Apr. 1, 2010

(54) STACKABLE SHOPPING CART

(76) Inventor: Herbert Eberlein, Bubesheim (DE)

Correspondence Address: HARNESS, DICKEY & PIERCE, P.L.C., P.O. BOX 828, BLOOMFIELD HILLS, MI, 48303, US

(21) Appl. No.: 12/514,965

(22) PCT Filed: Nov. 7, 2007
(86) PCT No.: PCT/DE07/01995

§ 371 Date: May 14, 2009

(30) Foreign Application Priority Data
Nov. 16, 2006 (DE) 10 2006 054 153.7

(51) Int. Cl. B62D 39/00

(52) U.S. Cl. 280/33.991

(57) ABSTRACT

The invention relates to a stackable shopping cart (1) having a chassis (2), a basket (9) and a pushing device (11), wherein two basket-carrying elements (13) are provided on the chassis (2), the basket (9) being attachable to the elements as part of an installation process by means of the two side walls (10). It is proposed that each basket-carrying element (13) is equipped with an upper support section (14) and a lower support section (15), which is disposed with lateral offset to the upper support section (14), wherein each upper support section (14) is intended for attaching a side wall (10). It is furthermore proposed that at least two connecting point pairs (17) are provided on the chassis (2), and that each basket-carrying element (13) can be locked to one of the at least two connecting point pairs (17) by means of the lower support section (15).

The invention relates to a shopping cart which can be stacked together with identical shopping carts, said cart being provided with a chassis, with a basket and with a pushing device, wherein two basket-carrying elements are provided on the chassis, and the basket can be fastened by way of its two side walls to said basket-carrying elements during a mounting operation.

The majority of all shopping carts belonging to the prior art are shopping carts of this type. The method described above of fastening the basket to the chassis has proven to be reliable. Nevertheless, these shopping carts have a disadvantage which cannot be underestimated, namely that the basket width is geared to the width of the chassis and, conversely, the width of the chassis is geared to the width of the basket. The consequence is that, for each basket width, a chassis of corresponding width is required, a situation which has since disadvantageously resulted in a multiplicity of different baskets and chassis, with the further consequence of excessive, and hence cost-intensive, stockholding.

It is the object of the invention to develop a shopping cart of the type in question here in such a way that the drawbacks just described can be avoided.

The object is achieved in that each basket-carrying element has an upper supporting portion and is equipped with a lower supporting portion which is arranged with a lateral offset with respect to the upper supporting portion, wherein each upper supporting portion is intended for fastening a side wall, in that furthermore at least two connecting point pairs are provided on the chassis, and in that the basket-carrying elements can be locked in place by their lower supporting portion on one of the at least two connecting point pairs.

By contrast with the prior art, the present invention advantageously differs from the solution used to date of configuring the basket-carrying elements as straps which are made of flat steel or of thick sheet metal and arranged on end. The planar basket-carrying elements are now replaced by ones having a laterally offset shape or else angled shape which, together with the at least two predetermined connecting points arranged in pairs, make it possible in an extremely advantageous manner for at least two baskets of different width to be attached to one and the same chassis. Thus, for example, it is possible to attach to the same chassis in one instance a basket which is wider than the chassis, or else to attach a basket which can be designed, for example, to have the same width as the chassis or else even a smaller width than the chassis. In this way it is possible to save on all those chassis which have to date differed only in terms of their different width but which are identical in length and height. The invention thus reduces the variety of types of chassis and thereby avoids excessive stockholding. It is thus possible for identical chassis according to the proposed invention to be produced in significantly larger unit quantities, resulting noticeably in lower production costs.

The invention will be explained in more detail below by way of exemplary embodiments. In the drawing:

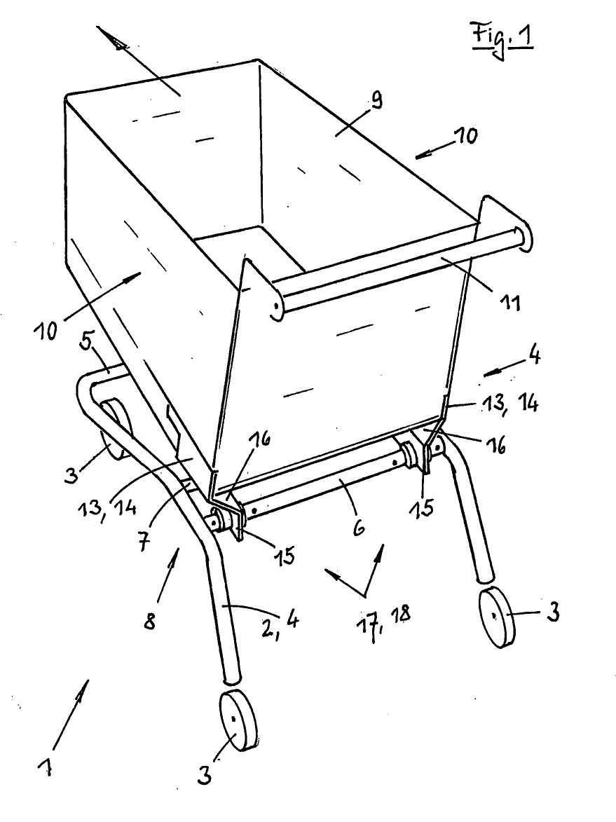

FIG. 1 shows a shopping cart in a three-dimensional representation;

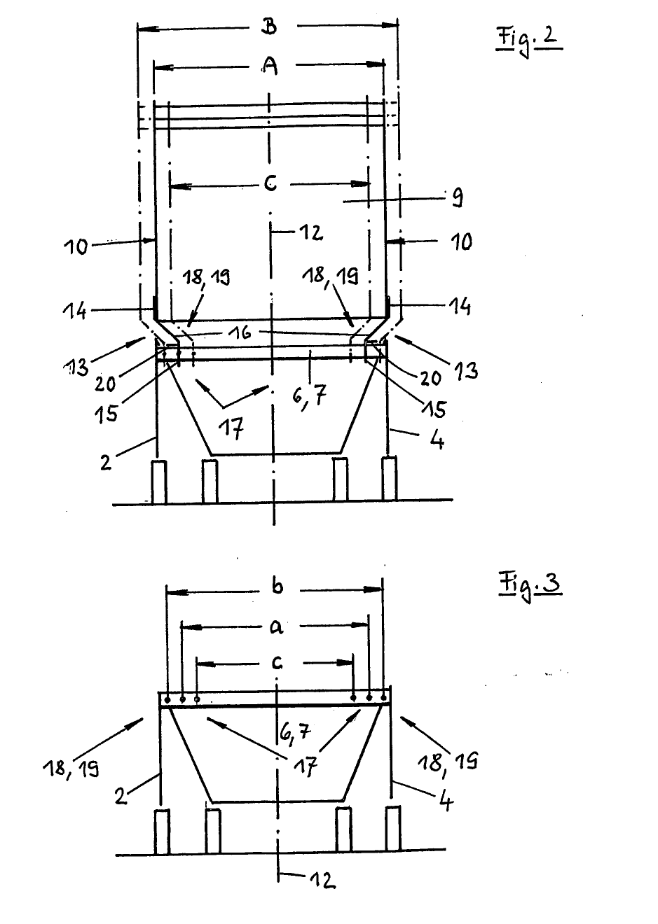

FIG. 2 shows the same shopping cart in a rear view with baskets of different width, and

FIG. 3 shows, likewise in a rear view, an advantageous arrangement of the connecting point pairs on the chassis.

The shopping cart 1 represented in FIG. 1 is tailored in its external form to standard commercial shopping carts 1. The shopping cart 1 comprises a chassis 2 which is supported by castors 3. In the example, the chassis 2 has two upwardly curved longitudinal arms 4 which are connected by a front cross-strut 5 and by rear and front crossbars 6 and 7, wherein said crossbars are situated in the upper region 8 of the longitudinal arms 4. Arranged close to the two longitudinal arms 4 on the rear and front crossbars 6, 7, that is to say on the chassis 2, are two basket-carrying elements 13 which extend in the pushing direction (arrow) of the shopping cart 1. The chassis 2 carries a basket 9 having a pushing device 11, wherein the basket 9 is fastened by way of its two side walls 10 to a respective basket-carrying element 13. The shopping cart 1 is designed in a known manner such that, likewise in a known manner, it can be pushed in space-saving fashion into an identical shopping cart 1, that is to say can be stacked therewith. As is known practice, this is achieved by a conical design of the chassis 2 and the basket 9 and with the provision of a pivotable gate (not shown in more detail) which closes off the rear side of the basket 9.

FIG. 2 shows the shopping cart 1 represented in FIG. 1 in a rear view. There can be seen the chassis 2, the two basket-carrying elements 13 and the basket 9. There can also be seen the virtually congruent crossbars 6 and 7 on which the two basket-carrying elements 13 are arranged securely against detachment. Three baskets 9 of different width are depicted. The basket 9 drawn with solid lines is as wide as the chassis 2 in the example. Dot-dashed lines are used to represent both a basket 9 which is of wider design than the chassis 2 and a basket 9 having a narrower design than the chassis 2. This is illustrated by the dimensions A, B and C. The two basket-carrying elements 13 are also depicted correspondingly. The two basket-carrying elements 13 are each arranged and configured with mirror symmetry with respect to the vertical center axis 12 of the shopping cart 1. By contrast with the prior art, the basket-carrying elements 13 are designed in a laterally offset manner. Each upper supporting portion 14 of the basket-carrying elements 13 is connected to a side wall 10 of the corresponding basket 9. Offset laterally with respect to the upper supporting portion 14, each basket-carrying element 13 has a lower supporting portion 15. Connecting point pairs 17 are provided on the crossbars 6, 7, and the basket-carrying elements 13 can be locked in place by their lower supporting portion 15 on said pairs. In the case of each of the two basket-carrying elements 13, the upper supporting portion 14 is connected to the lower supporting portion 15 via a connecting portion 16 which is directed, preferably in an obliquely sloping manner, toward the vertical center axis 12 of the shopping cart 1. The oblique arrangement of the connecting portions 16 prevents dirt from depositing. Since the basket-carrying elements 13 can be fastened to the chassis 2 in different positions adapted to the respective width of a basket 9, it is possible, with one and the same chassis 2 and using always the same basket-carrying elements 13, to produce shopping carts 1 having baskets 9 of different width. It is appropriate to make the basket-carrying elements 13 of stable plastic so that they can be attached securely against detachment to the predetermined connecting point pairs 17. At least two connecting points pairs 17 are provided. In the example, there are three connecting point pairs 17, with each connecting point pair 17 requiring at least one crossbar 6 or 7, generally both crossbars 6, 7.

Each connecting point pair 17 is thus preferably formed by in each case two connecting points 18, wherein the respective first connecting point 18 is situated on the rear crossbar 6 and the respective second connecting point 18 is situated on the front crossbar 7. Depending on the particular width of the basket 9, the appropriate connecting point pair 17 for fastening the basket-carrying elements 13 is thus selected. In order to additionally support the basket-carrying elements 13, said elements can be equipped with a shoulder 20 which is supported on the chassis 2, in particular on the crossbar 6 and/or on the crossbar 7, while projecting outwardly from the center axis 12.

FIG. 3 shows the same shopping cart 1, likewise in a rear view, but without a basket 9. Three connecting point pairs 17 arranged in pairs can be seen. Their respective mirror-symmetrical arrangement is denoted by the dimensions a, b and c. The connecting point pairs 17, which can be configured in various ways, are symbolically formed in the example by holes 19 or bores 19 which are situated in the rear and front crossbars 6, 7. As long as they are made of plastic, the required basket-carrying elements 13 can be attached to the two crossbars 6, 7 with a snap fit while adopting a selected connecting point pair 17 and while adopting the appropriate holes or bores 19. Depending on which of the connecting point pairs 17 arranged at different widths are adopted, it is possible using always the same basket-carrying elements 13 for baskets 9 of different width to be attached to one and the same chassis 2. It can be seen, in conjunction with FIG. 2, that the width of each basket 9, for example the width A, is greater than the horizontally measured distance a in the case of the correspondingly assigned connecting point pair 17. Thus, B is therefore also greater than b and C is likewise greater than c. The connecting point pairs 17 are arranged between the longitudinal arms 4 of the chassis 2, although it should also be mentioned that the longitudinal arms 4 shown can be replaced by known carriers of some other design that support the basket 9. The term longitudinal arms 4 expressly includes such carriers belonging to the prior art.

The basket-carrying elements 13 can be designed in various ways. They will preferably have a mirror-symmetrical design. There is usually one right and one left basket-carrying element 13 for each shopping cart 1. As has already been mentioned, plastic is an appropriate material for producing the basket-carrying elements 13. However, basket-carrying elements 13 made of metal, for example in the form of die castings, are also possible, with all such elements having the laterally offset basic shape in common. The basket-carrying elements 13 can be detachably fastened to the chassis 2 during a mounting operation, which means that they can also be demounted easily if required.

1. A stackable shopping cart, provided with a chassis, with a basket and with a pushing device, wherein two basket-carrying elements are provided on the chassis, and the basket can be fastened by way of its two side walls to said basket-carrying elements during a mounting operation, characterized in that each basket-carrying element has an upper supporting portion and is equipped with a lower supporting portion which is arranged with a lateral offset with respect to the upper supporting portion, wherein each upper supporting portion is intended for fastening a side wall, in that furthermore at least two connecting point pairs are provided on the chassis, and in that each basket-carrying element can be locked in place by its lower supporting portion on one of the at least two connecting point pairs.

2. The stackable shopping cart of claim 1, wherein the two basket-carrying elements are arranged with mirror symmetry with respect to the vertical center axis of the shopping cart.

3. The stackable shopping cart of claim 1, wherein the upper supporting portion is connected to the lower supporting portion of each basket-carrying element by a connecting portion.

4. The stackable shopping cart of claim 3, wherein the connecting portion of each basket-carrying element is arranged so as to be obliquely directed toward the center axis.

5. The stackable shopping cart of claim 1, wherein the connecting point pairs are arranged between the longitudinal arms of the chassis.

6. The stackable shopping cart of claim 5, wherein the connecting point pairs are arranged on rear and front crossbars which connect the longitudinal arms.

7. The stackable shopping cart of claim 1, wherein the width of the respective basket is greater than the distance between the corresponding connecting point pair.

8. The stackable shopping cart of claim 1, wherein each basket-carrying element is equipped with a shoulder which is intended for additionally supporting the basket-carrying elements on the crossbar and/or.

9. The stackable shopping cart of claim 1, wherein the basket-carrying elements are made of plastic or metal.
